(19) United States
(12) Patent Application Publication
(10) Pub. No.: US 2019/0278399 A1
(43) Pub. Date: Sep. 12, 2019

(54) INPUT SENSOR AND DISPLAY DEVICE INCLUDING THE SAME

(71) Applicant: DONGWOO FINE-CHEM CO., LTD., Iksan-si (KR)

(72) Inventors: Byung Jin CHOI, Siheung-si (KR); Minhyuk PARK, Gangreung-si (KR); Seonghwan PARK, Hwaseong-si (KR)

(73) Assignee: DONGWOO FINE-CHEM CO., LTD, Iksan-si (KR)

(21) Appl. No.: 16/295,019

(22) Filed: Mar. 7, 2019

(30) Foreign Application Priority Data
Mar. 7, 2018 (KR) 10-2018-0027126
Dec. 21, 2018 (KR) 10-2018-0167935

(51) Int. Cl. G06F 3/044; G06F 3/045; G06F 3/041

(52) U.S. Cl. CPC G06F 3/044; G06F 3/045; G06F 2203/04102; G06F 2203/04111; G06F 2203/04105; G06F 3/0416

(57) ABSTRACT

The present invention relates to an input sensor capable of sensing writing pressure and a display device including the same.

### CROSS REFERENCE TO RELATED APPLICATIONS

The application claims priority based on Korean Patent Application No. 10-2018-0027126 filed Mar. 7, 2018, and Korean Patent Application No. 10-2018-0167935 filed Dec. 21, 2018, the contents of which are incorporated herein by reference in their entirety.

### Technical Field

The present invention relates to an input sensor and a display device including the same. Particularly, the present invention relates to an input sensor capable of sensing writing pressure and a display device including the same,

### Background Art

In recent display devices, a touch input method in which a user directly touches a screen using a finger to input is widely used. The touch input method can be combined with a display screen without a separate input device such as a keyboard and a mouse and provide an intuitive and convenient user interface by allowing a user to directly touch a specific location of the display screen to input.

Currently a capacitive type touch sensor is widely used, in which a transparent conductive material is used to form a touch sensing electrode pattern of the touch sensor. Since the touch sensor is normally used by touching a screen with a finger, the sensing electrode pattern is formed in consideration of the finger size of a person. For example, Korean Patent Application Publication No. 10-2016-0105947 discloses a touch screen sensor including touch sensitive zones having 5 mm×5 mm square areas.

The capacitive type touch sensor that performs input using the fingers has a limitation in designating precise coordinates. Accordingly, a digitizer using an electro-magnetic resonance (EMR) method utilizing a pen is advantageously used for precise graphic input.

A prior art digitizer using the EMR method is disclosed in International Patent Application Publication WO 2010/023861 A1, wherein the digitizer comprises an indicator and a position detecting device for sensing the indicator. The position detecting device includes a driving loop line group, a sensing loop line group, a detection surface on which the driving loop line group and the sensing loop line group are arranged, an identification unit, and a detection unit. A plurality of U-shaped linear loop lines in the driver loop line group and a plurality of U-shaped linear loop lines in the detection loop line group are orthogonal to each other. On the basis of the change in the degree of electromagnetic coupling of the driver loop line group and the detection loop line group, the detection unit detects a position indicated by the indicator.

Such an EMR type digitizer has advantages of precise coordinate designation and handwriting pressure recognition, but it is complicated in construction and requires a specific indicator.

Meanwhile, Korean Patent Application Publication No. 10-2016-0056682 discloses a touch pressure sensing apparatus comprising a touch pen including a pen tip with a conductive fluid; a touch sensor including a plurality of driving electrodes and a plurality of sensing electrodes; and a controller for determining a touch pressure based on a contact area between the pen tip and the touch sensor.

The touch pressure sensing apparatus of Korean Patent Application Publication No. 10-2016-0056682 is capable of sensing a writing pressure without a pressure sensor, but still has the inconvenience of using a specific indicating apparatus which is a touch pen including a pen tip with a conductive fluid.

### DISCLOSURE OF INVENTION

### Technical Problem

It is an object of the present invention to provide an input sensor capable of sensing a writing pressure without using a specific indicator and a display device including the same. Another object of the present invention is to provide an input sensor capable of sensing a writing pressure which is simple in construction and can be manufactured at a low cost and a display device including the same.

### Technical Solution

According to one aspect of the present invention, there is provided an input sensor, comprising: a touch sensor including a touch sensor pattern having a pattern pitch of 1 to 3 mm; a pressure sensor arranged over or under the touch sensor; and a signal processing unit connected to the touch sensor and the pressure sensor.

The signal processing unit may output a touch input signal corresponding to a pen input and a pressure signal corresponding to the pen input together.

The touch sensor may include: a substrate; a separation layer on the substrate; a protective layer formed on the separation layer; an outgas sing prevention layer formed on the protective layer; a touch sensor pattern layer formed on the outgas sing prevention layer and containing a transparent conductive material; an insulation layer formed on the touch sensor pattern layer; and a bridge layer formed on the insulation layer and containing a metallic material.

The touch sensor may include: a substrate; a separation layer on the substrate; a protective layer formed on the separation layer; an outgas sing prevention layer formed on the protective layer; a bridge layer formed on the outgassing prevention layer and containing a metallic material; an insulation layer formed on the bridge layer; and a touch sensor pattern layer formed on the insulation layer and containing a transparent conductive material.

The substrate of the touch sensor may be a flexible substrate.

The pressure sensor may be a capacitive type pressure sensor.

The pressure sensor may be a resistive type pressure sensor.

According to another aspect of the present invention, there is provided a display device comprising: a display layer; a touch sensor arranged over the display layer; a pressure sensor arranged over or under the display layer; and a signal processing unit connected to the touch sensor and the pressure sensor, wherein the touch sensor has a pattern pitch of 1 to 3 mm.

The display device may further comprise a cover window arranged over the display layer, the touch sensor and the pressure sensor.

The cover window may be made of glass.

The cover window may be made of a flexible film substrate.

The signal processing unit may output a touch input signal corresponding to a pen input and a pressure signal corresponding to the pen input together.

The display layer may be an OLED layer or an LCD layer.

### Advantageous Effects

The input sensor according to the present invention can sense the writing pressure of the pen according to the input without using a specific indicating apparatus, has a simple structure, and can be manufactured at a low cost.

### DESCRIPTION OF DRAWINGS

FIG. 1 is a cross-sectional view of a display device according to the first embodiment of the present invention.

FIG. 2 is a graph showing a change in the linearity according to the pitch of the touch sensor.

FIG. 3 is a cross-sectional view of a touch sensor according to an embodiment of the present invention.

FIG. 4 is a cross-sectional view of a display device according to the second embodiment of the present invention.

FIG. 5 is a cross-sectional view of a display device according to the third embodiment of the present invention.

FIG. 6 is a flowchart showing an input sensing method according to an embodiment of the present invention.

### BEST MODE

Hereinafter, preferred embodiments of the present invention will be described in detail with reference to the accompanying drawings. However, the drawings accompanying the present disclosure are mere examples for describing the present invention, and the present invention is not limited by the drawings. Also, some elements may be exaggerated, scaled-down, or omitted in the drawing for clearer expressions.

The present invention provides an input sensor capable of sensing writing pressure using a touch sensor having a fine pattern and a pressure sensor, and a display device including the same,

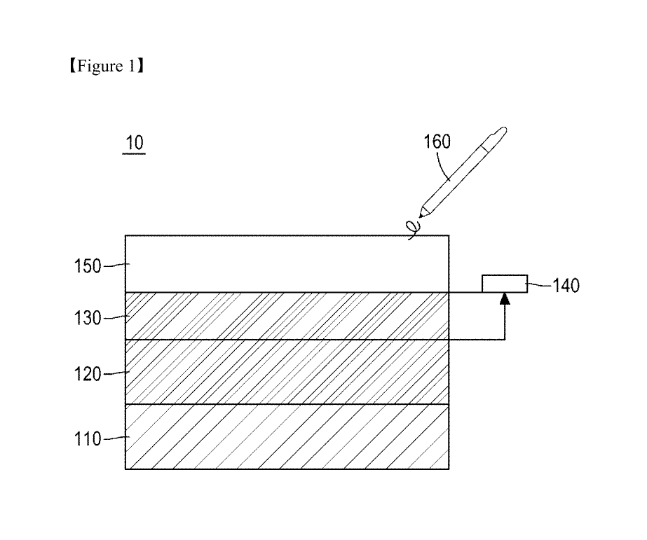

FIG. 1 is a cross-sectional view of a display device according to the first embodiment of the present invention.

Referring to FIG. 1, the display device 10 according to the first embodiment of the present invention comprises a display layer 110, a pressure sensor 120 on the display layer 110, a touch sensor 130 on the pressure sensor 120, a signal processing unit 140 connected to the pressure sensor 120 and the touch sensor 130, and a cover window 150 on the touch sensor 130.

As the display layer 110, any type of display layer applicable to a flexible display device can be used without limitation, and, for example, an OLED layer or an LCD layer may be used.

As the pressure sensor 120, any type of pressure sensor applicable to a flexible display device can be used without limitation.

The pressure sensor 120 may be a capacitive type or a resistive type pressure sensor.

The capacitive type pressure sensor senses a change in capacitance corresponding to a displacement of the pressure sensor by a signal processing unit.

The resistive type pressure sensor senses a change in resistance corresponding to a pressure of the pressure sensor by a signal processing unit.

The capacitive type pressure sensor has a sensing electrode formed on a film substrate such as PI, PET, COP, TAC, PES, PC, and acrylic film and may have a cushion layer to make a displacement of the pressure sensor over or under the sensing electrode.

The resistive type pressure sensor may include a material whose resistance varies with pressure on a film substrate such as PI, PET, COP, TAC, PES, PC, and acrylic film.

In addition, the resistive type pressure sensor may employ a method in which one electrode formed on the upper film substrate and the other electrode formed on the lower film substrate are in contact with each other to generate resistance.

The touch sensor 130 is a capacitive type touch sensor, which may have a fine pattern capable of sensing a touch input using a pen 160 as well as a touch input using a finger. The touch sensor 130 may have a pattern having a pitch of 1 to 3 mm.

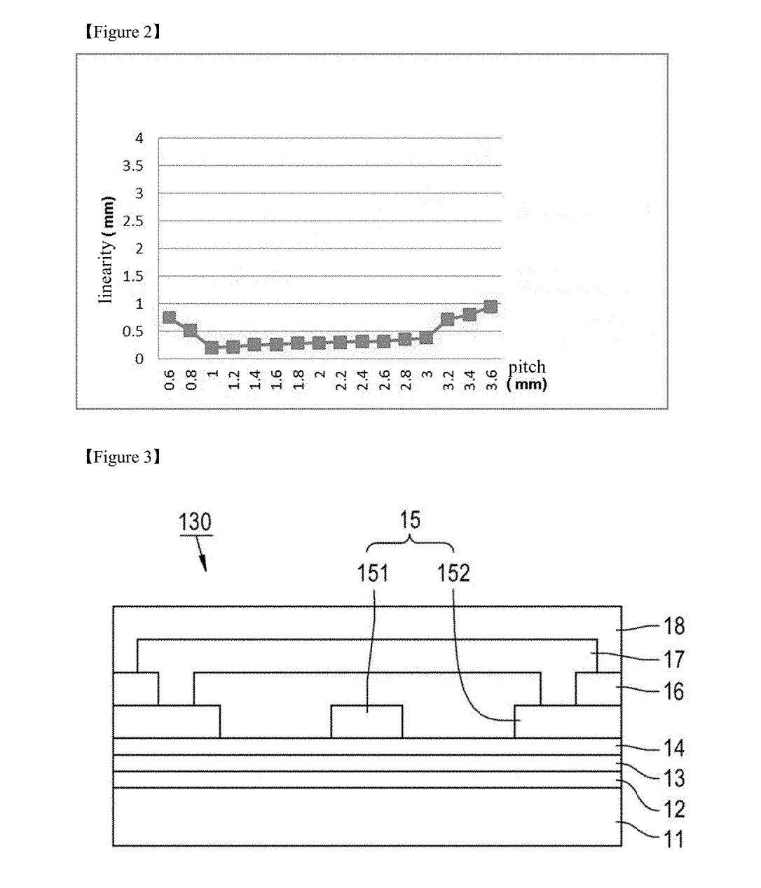

FIG. 2 is a graph showing a change in the linearity according to the pitch of the touch sensor.

The touch sensor of the present invention can also be configured to function as a digitizer. For this purpose, it may be desirable to increase the resolution, that is, to increase the number of channels by narrowing the pattern pitch. However, a pen used with a digitizer generally has a diameter of 1Φ, i.e., a diameter of a conductive rod of 1 mm or less. In this case, it is necessary to maintain the linearity within a tolerance of 0.5 mm.

As shown in FIG. 2, the linearity was measured while changing the pattern pitch when the 11 pen was used, and the results shown in Table 1 were obtained.

TABLE 1

| Pattern pitch (mm) | Linearity (mm) |
|---|---|
| 0.6 | 0.75 |
| 0.8 | 0.51 |
| 1.0 | 0.20 |
| 1.2 | 0.22 |
| 1.4 | 0.25 |
| 1.6 | 0.26 |
| 1.8 | 0.28 |
| 2.0 | 0.29 |
| 2.2 | 0.30 |
| 2.4 | 0.31 |
| 2.6 | 0.32 |
| 2.8 | 0.35 |
| 3.0 | 0.38 |
| 3.2 | 0.72 |
| 3.4 | 0.80 |
| 3.6 | 0.95 |

As can be seen in Table 1, the pattern pitch in which the tolerance of the linearity is maintained within 0.5 mm when using the 1Φ pen is 1 to 3 mm.

FIG. 3 is a cross-sectional view of a touch sensor 130 according to an embodiment of the present invention.

Referring to FIG. 3, the touch sensor 130 according to an embodiment of the present invention comprises a substrate 11, a separation layer 12 formed on the substrate 11, a protective layer 13 formed on the separation layer 12, and an outgassing prevention layer 14 formed on the protective layer 13, and a touch sensor pattern layer 15 is formed on the outgas sing prevention layer 14.

In an embodiment of the present invention, the substrate 11 may be a flexible film substrate, in particular, a transparent film or a polarizing plate.

The transparent film is not limited if it has good transparency, mechanical strength and thermal stability. Specific examples of the transparent film may include thermoplastic resins, e.g., polyester resins such as polyethylene terephthalate, polyethylene isophthalate, polyethylene naphthalate and polybutylene terephthalate; cellulose resins such as diacetylcellulose and triacetylcellulose; polycarbonate resins; acrylate resins such as polymethyl (meth)acrylate and polyethyl (meth)acrylate; styrene resins such as polystyrene and acrylonitrile-styrene copolymer; polyolefin resins such as polyethylene, polypropylene, polyolefin having a cyclic or norbornene structure, and ethylene-propylene copolymer; vinyl chloride resins; amide resins such as nylon and aromatic polyamide; imide resins; polyethersulfone resins; sulfone resins; polyether ether ketone resins; polyphenylene sulfide resins; vinyl alcohol resins; vinylidene chloride resins; vinyl butyral resin; allylate resin; polyoxymethylene resins; and epoxy resins. Also, a film consisting of a blend of the thermoplastic resins may be used. In addition, thermally curable or UV curable resins such as (meth)acrylate, urethane, acrylic urethane, epoxy and silicon resins may be used.

Such a transparent film may have a suitable thickness. For example, considering workability in terms of strength and handling, or thin layer property, the thickness of the transparent film may range from 1 to 500 μm , preferably 1 to 300 μm, more preferably 5 to 200 μm.

The transparent film may contain at least one suitable additive. Examples of the additive may include an UV absorber, an antioxidant, a lubricant, a plasticizer, a releasing agent, a coloring-preventing agent, an anti-flame agent, an anti-static agent, a pigment and a colorant. The transparent film may comprise various functional layers including a hard coating layer, an anti-reflective layer and a gas barrier layer, but the present invention is not limited thereto. That is, other functional layers may also be included depending on the desired use.

If necessary, the transparent film may be surface-treated. For example, the surface treatment may be carried out by drying method such as plasma, corona and primer treatment, or by chemical method such as alkali treatment including saponification.

Also, the transparent film may be an isotropic film, a retardation film or a protective film.

In the case of the isotropic film, it is preferred to satisfy an in-plane retardation (Ro) of 40 nm or less, preferably 15 nm or less and a thickness retardation (Rth) of −90 nm to +75 nm, preferably −80 nm to +60 nm, particularly −70 nm to +45 nm, the in-plane retardation (Ro) and thickness retardation (Rth) being represented by the following equations.

Ro=[(nx−ny)×d]

Rth=[(nx+ny)/2−nz]×d

wherein, nx and ny are each a main refractive index in a film plane, nz is a refractive index in the thickness direction of film, and d is a thickness of film.

The retardation film may be prepared by uniaxial stretching or biaxial stretching of a polymer film, coating of a polymer or coating of a liquid crystal, and it is generally used for improvement or control of optical properties, e.g., viewing angle compensation, color sensitivity improvement, light leakage prevention, or color control of a display.

The retardation film may include a half-wave (½) or quarter-wave (¼) plate, a positive C-plate, a negative C-plate, a positive A-plate, a negative A-plate, and a biaxial plate.

The protective film may be a polymer resin film comprising a pressure-sensitive adhesive (PSA) layer on at least one surface thereof, or a self-adhesive film such as a polypropylene.

The polarizing plate may be any one known to be used in a display panel.

Specifically, PVA (polyvinyl alcohol), TAC (triacetyl cellulose), or COP (cycloolefin polymer) based films can be used, but the present invention is not limited thereto.

The separation layer 12 is a layer formed for peeling off from a carrier substrate after the preparation of the touch sensor is completed in the manufacturing process of the present invention. Accordingly, the separation layer 12 can be separated from the carrier substrate by a physical force and it is laminated on the film substrate 11 after separation.

The protective layer 13 is to protect the separation layer 12 and formed on the separation layer 12.

In an embodiment of the present invention, the separation layer 12, or the protective layer 13, or both the separation layer 12 and the protective layer 13 may be made of organic layers to provide a flexible touch sensor.

The organic layers may be made of polymer. The polymer may comprise at least one selected from the group consisting of polyacrylate, polymethacrylate (e.g., PMMA), polyimide, polyamide, poly vinyl alcohol, polyamic acid, polyolefin (e.g., PE, PP), polystylene, polynorbornene, phenylmaleimide copolymer, polyazobenzene, polyphenylenephthalamide, polyester (e.g., PET, PBT), polyarylate, cinnamate polymer, coumarin polymer, phthalimidine polymer, chalcone polymer and aromatic acetylene polymer.

The organic material comprised in the separation layer 12, or the protective layer 13, or both of the separation layer 12 and the protective layer 13 may cause outgassing during the manufacturing process. The gas generated from the organic material causes non-uniformity in the film forming process thereon and may also damage the layer thereon, resulting in difficulties in formation of a fine pattern.

In order to solve such a problem, the outgassing prevention layer 14 composed of an inorganic film or an organic film is formed on the protective layer 13 in an embodiment of the present invention.

The outgassing prevention layer 14 may be formed of an inorganic layer, and may be a single layer or a laminated layer containing a metal oxide or a metal nitride. Specifically, it may include any one of SiNₓ, SiON, Al₂O₃, SiO₂, and TiO₂. For example, the outgassing prevention layer 14 may be formed of a SiON layer or a SiO₂ layer, or a double layer of SiON and SiO₂.

The thickness of the outgas sing prevention layer 14 may be 100 nm to 400 nm.

When the thickness of the outgassing prevention layer is less than 100 nm, the outgassing prevention effect is insufficient, which causes unevenness of film formation. When the thickness is larger than 400 nm, cracks may occur when the touch sensor is separated from the carrier substrate after manufacturing.

Specifically, when the outgas sing prevention layer 14 is formed of a single layer of a SiON layer or an SiO₂ layer, the thickness of the single layer can be 100 nm to 400 nm. When the outgassing prevention layer 14 is formed of a double layer of SiON and SiO₂, the thickness of each layer may be 100 nm to 200 nm.

The outgassing prevention layer 14 may be formed of an organic layer. As the material of the organic layer, an insulating material known in the art may be used without limitation. A non-metal oxide such as silicon oxide, a photosensitive resin composition containing an acrylic resin, or a thermosetting resin composition may be used.

The outgas sing prevention layer 14 may be formed of, for example, an epoxy-based, polycyclolefin-based, or acrylic-based material, and may have a thickness of 10 nm to 5 μm.

Alternatively, the outgas sing prevention layer 14 may be a gas barrier film. The barrier film may have a structure that an organic layer and an inorganic layer are stacked alternately.

The inorganic layer deposited as the outgassing prevention layer 14 or the inorganic layer included in the barrier film may be formed to prevent moisture permeation.

As the outgassing prevention layer 14 is formed on the protective layer 13, the gas generated from the protective layer 13 and the separation layer 12 under the outgassing prevention layer 14 can be blocked not to affect the layer thereon during the film forming and patterning process. Specifically, when the outgassing is prevented, the transparent conductive material forming the touch sensor pattern layer 15 formed on the outgassing prevention layer 14 can have a uniform resistance.

Also, the outgassing prevention layer 14 can be used as a functional layer that facilitates formation of a fine electrode pattern on the outgas sing prevention layer 14. That is, by forming the outgassing prevention layer 14, the surface is planarized and the adhesion with the transparent conductive material forming the touch sensor pattern layer 15 is improved in the patterning process. Thus, the etching rate can be precisely controlled and the etched cross-section of the transparent conductive material can be formed to have a forward tapered shape instead of a reverse tapered shape, thereby enabling to form a fine pattern.

In addition, the outgas sing prevention layer 14 can perform the function of the etch barrier layer in the patterning process thereon. For example, the separation layer 12 and the protective layer 13 located under the outgassing prevention layer 14 can be protected against damage while dry etching other inorganic layers such as an insulation layer that can be formed over the outgassing prevention layer 14.

In an embodiment of the present invention, the touch sensor pattern layer 15 is formed on the outgassing prevention layer 14.

Here, each of the touch sensing electrodes 151 and 152 may be a unit capable of sensing a touch input. The width of one unit forming a repetitive pattern including the space between the touch sensing electrodes 151 and 152 may be defined as the pitch of the touch sensing electrode pattern.

According to an embodiment of the present invention, by forming the touch sensor pattern layer 15 on the outgassing prevention layer 14, it is possible to obtain a fine touch sensor pattern having a pitch of 3 mm or less owing to the function of the outgassing prevention layer 14 described above. As a result, it is possible to accurately detect not only the input using a finger but also the input using a pen having a smaller touch area than the finger.

The touch sensor pattern layer 15 is a transparent conductive layer, which may be formed of one or more materials selected from metal meshes, metal nanowires, metal oxides, carbon nanotubes, graphene, conductive polymers and conductive inks.

Here, the metal forming metal meshes may be any one of gold, silver, copper, molybdenum, aluminum, palladium, neodymium, platinum, zinc, tin, titanium or alloys thereof.

Examples of the metal nanowire may include silver nanowire, copper nanowire, zirconium nanowire, and gold nanowire.

Examples of the metal oxide may include indium tin oxide (ITO), indium zinc oxide (IZO), indium zinc tin oxide (IZTO), aluminum zinc oxide (AZO), gallium zinc oxide (GZO), fluorine-doped tin oxide (FTO), and zinc oxide (ZnO).

Also, the touch sensor pattern layer 15 may be formed of carbon materials such as carbon nanotube (CNT) and graphene.

The conductive polymer may comprise polypyrrole, polythiophene, polyacetylene, PEDOT and polyaniline, and the conductive ink may be a mixture of metal powder and a curable polymer binder.

If necessary, the touch sensor pattern layer 15 may consist of two or more conductive layers so as to reduce electric resistance.

For example, the touch sensor pattern layer 15 may consist of a single layer of ITO, AgNW (silver nanowire) or a metal mesh, or two or more layers comprising a first electrode layer of a transparent metal oxide such as ITO, and a second electrode layer of a metal or AgNW formed on the ITO electrode layer so as to lower electric resistance.

An insulation layer 16 is formed on the touch sensor pattern layer 15 to electrically isolate the first touch sensing electrode 151 and the second touch sensing electrode 152 from each other.

A plurality of second touch sensing electrodes 152 which belong to cells constituting individual sensing areas respectively and are separated from each other are connected via a bridge 17 through holes in the insulation layer 16.

The insulation layer 16 may be formed over the entire surface of the touch sensor pattern layer 15, or may be patterned to have an island shape on a connecting portion where the first touch sensing electrodes 151 are connected to each other.

In an embodiment of the present invention, the insulation layer 16 may be formed of an inorganic layer.

As described above, an inorganic layer can be used as the insulation layer 16 because the outgassing prevention layer 14 can protect the separation layer 12 and the protective layer 13 from damage during dry etching process of the insulation layer 16.

On the other hand, an organic layer can also be used as the insulation layer 16.

The bridge 17 is formed on the insulation layer 16 to electrically connect the second touch sensing electrodes 152 to each other.

The bridge 17 can be made of any conductive material, for example, a metal. Here, the metal may be any one of gold, silver, copper, molybdenum, aluminum, palladium, neodymium, platinum, zinc, tin, titanium or alloys thereof.

A passivation layer 18 is formed on the bridge 17.

The passivation layer 18 may be formed of an organic layer or an inorganic layer.

As a material of the passivation layer 18, an insulating material known in the art may be used without limitation, and a non-metal oxide such as silicon oxide, a photosensitive resin composition including an acrylic resin or a thermosetting resin composition may be used.

The passivation layer 18 may be formed of, for example, an epoxy-based material, and may have a thickness of 10 nm to 5 μm.

The passivation layer 18 may be formed of, for example, a polycycloolefin-based material, and may have a thickness of 10 nm to 5 μm.

Also, the passivation layer 18 may be formed of, for example, an acrylic-based organic insulation film material, and may have a thickness of 10 nm to 5 μm.

Meanwhile, the touch sensor 130 according to an embodiment of the present invention shown in FIG. 3 has a structure that the first and second touch sensing electrodes 151 and 152 are formed on the outgassing prevention layer 14 and the bridge 17 is formed on the insulation layer 16. However, the structure of the touch sensor 130 is not limited thereto. Rather, any structure can be employed as long as a fine pattern enabling to sense a touch input using the pen 160 may be formed. For example, a bridge may be first formed on the outgassing prevention layer, and then a touch sensing electrode may be formed thereon with an insulation layer interposed therebetween.

The pressure sensor 120 and the touch sensor 130 are connected to the signal processing unit 140. The signal processing unit 140 is a unit processing signals regarding pressures and touches sensed by the pressure sensor 120 and the touch sensor 130, which may be made of one IC or two ICs connected to the pressure sensor 120 and the touch sensor 130, respectively.

According to an embodiment of the present invention, when a handwriting application with the pen 160 for handwriting is used, the signal processing unit 140 can implement the pressure sensing function by outputting the handwriting pressure together with the touch position. The signal processing flow of the signal processing unit 140 will be described later.

As the material of the cover window 150, glass or a flexible transparent substrate can be used. However, it is not particularly limited as long as it is durable enough to sufficiently protect the display device 10 from external force and allows the user to view the display well through it.

When the glass is used for the cover window 150, its thickness is not particularly limited, but may be 8 to 1000 μm, specifically 20 to 300 μm. If the thickness of the cover window 150 is less than 8 μm, the strength is lowered and the workability is deteriorated. If the thickness is more than 1000 μm, the transparency may be lowered or the weight of the cover window 150 may be increased.

Further, for the flexible display device, a flexible film substrate can be used as the cover window 150. As the flexible film substrate material, materials having transparency and flexibility can be used without limitation. For example, a material similar to that used for the substrate 11 of the touch sensor 130 described with reference to FIG. 3 can be used.

The pen 160, which can be used for input in the display device 10 according to the first embodiment of the present invention, does not require any specific function or configuration for input, and anything can be used without limitation as long as it has a tip shape for the touch.

For example, when using a capacitive type pressure sensor, a pen comprising a conductive material may be more suitable. For example, a pen using a conductive material such as a pencil containing carbon, a chopstick containing metal, and a pen made of a non-conductive material with conductive coating of carbon and so on can be used without limitation.

When a resistive type pressure sensor is used, the pen does not have to include a conductive material, and any material may be used.

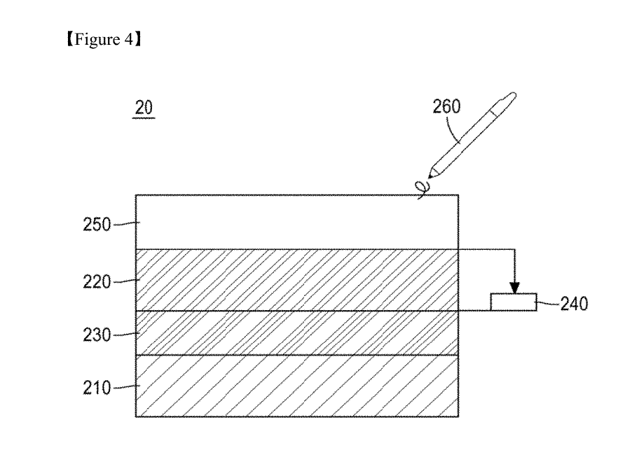

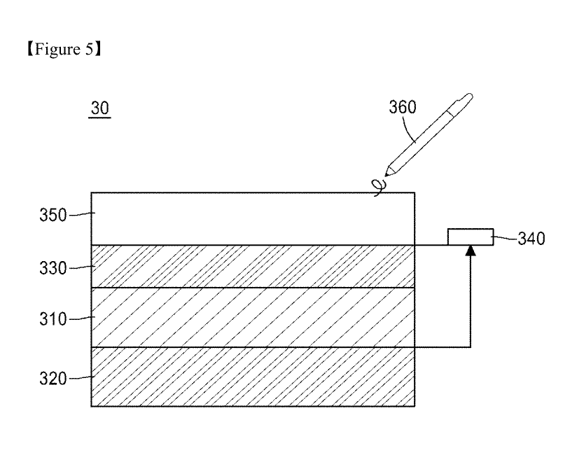

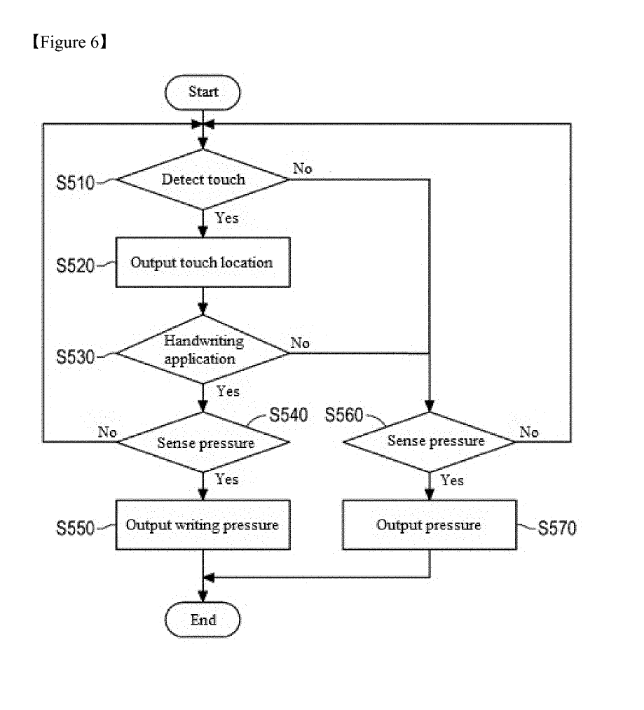

Meanwhile, the lamination structure of the display layer, the pressure sensor, and the touch sensor is not limited to that shown in FIG. 1, and it is possible to form in various structures. FIGS. 4 and 5 are cross-sectional views schematically showing display devices according to the second and third embodiments of the present invention, respectively.

Referring to FIG. 4, the display device 20 according to the second embodiment of the present invention includes a display layer 210, a touch sensor 230 on the display layer 210, a pressure sensor 220 on the touch sensor 230, a signal processing unit 240 connected to the pressure sensor 220 and the touch sensor 230, and a cover window 250 disposed on the pressure sensor 220.

Referring to FIG. 5, the display device 30 according to the third embodiment of the present invention includes a pressure sensor 320, a display layer 310 on the pressure sensor 320, a touch sensor 330 on the display layer 310, a signal processing unit 340 connected to the pressure sensor 320 and the touch sensor 330, and a cover window 350 disposed on the touch sensor 330.

The details of each component in the display devices 20 and 30 according to the second and third embodiments of the present invention are the same as those of the display device 10 according to the first embodiment of the present invention described with reference to FIGS. 1-3. Thus, the detailed description thereof will be omitted.

Now, an input sensing method of a display device according to an embodiment of the present invention will be described in detail. FIG. 6 is a flowchart schematically illustrating an input sensing method according to an embodiment of the present invention.

Referring to FIG. 6, when a touch using a user's finger or a pen is detected (S510), the signal processing unit outputs the touch location (S520).

At this time, if the application to be used is a handwriting application (S530), the pressure sensed by the pressure sensor (S540) is output as the writing pressure (S550). That is, the handwriting application can recognize or output the pressure of the pen.

Here, a handwriting application is intended to include all applications that use the pen. For example, a game application that uses a pen can also be a handwriting application.

If the application to be used is not a handwriting application (S530), the pressure sensed by the pressure sensor (S560) is output as the output of the general pressure sensor (S570).

As described above, according to an embodiment of the present invention, the writing pressure can be sensed by using the capacitive type touch sensor and the pressure sensor without a specific indicating apparatus.

Although particular embodiments and examples of the present invention have been shown and described, it will be understood by those skilled in the art that it is not intended to limit the present invention to the preferred embodiments, and it will be obvious to those skilled in the art that various changes and modifications may be made without departing from the spirit and scope of the invention.

The scope of the present invention, therefore, is to be defined by the appended claims and equivalents thereof.

### DESCRIPTION OF REFERENCE NUMERALS

10, 20, 30: display device
11: substrate
12: separation layer
13: protective layer
14: outgassing prevention layer
15: touch sensor pattern layer
151: first touch sensing electrode
152: second touch sensing electrode
16: insulation layer
17: bridge
18: passivation layer
110, 210, 310: display layer
120. 220, 320: pressure sensor
130, 230, 330: touch sensor
140, 240, 340: signal processing unit
150, 250, 350: cover window
160, 260, 360: pen

1. An input sensor, comprising:
a touch sensor including a touch sensor pattern having a pattern pitch of 1 to 3 mm;
a pressure sensor arranged over or under the touch sensor; and
a signal processing unit connected to the touch sensor and the pressure sensor.

2. The input sensor according to claim 1, wherein the signal processing unit outputs a touch input signal corresponding to a pen input and a pressure signal corresponding to the pen input together.

3. The input sensor according to claim 1, wherein the touch sensor includes:
a substrate;
a separation layer on the substrate;
a protective layer formed on the separation layer;
an outgas sing prevention layer formed on the protective layer;
a touch sensor pattern layer formed on the outgas sing prevention layer and containing a transparent conductive material;
an insulation layer formed on the touch sensor pattern layer; and
a bridge layer formed on the insulation layer and containing a metallic material.

4. The input sensor according to claim 1, wherein the touch sensor includes:
a substrate;
a separation layer on the substrate;
a protective layer formed on the separation layer;
an outgas sing prevention layer formed on the protective layer;
a bridge layer formed on the outgassing prevention layer and containing a metallic material;
an insulation layer formed on the bridge layer; and
a touch sensor pattern layer formed on the insulation layer and containing a transparent conductive material.

5. The input sensor according to claim 3, wherein the substrate is a flexible substrate.

6. The input sensor according to claim 1, wherein the pressure sensor is a capacitive type pressure sensor.

7. The input sensor according to claim 1, wherein the pressure sensor is a resistive type pressure sensor.

8. A display device comprising:
a display layer;
a touch sensor arranged over the display layer;
a pressure sensor arranged over or under the display layer; and
a signal processing unit connected to the touch sensor and the pressure sensor, wherein the touch sensor has a pattern pitch of 1 to 3 mm.

9. The display device according to claim 8, further comprising a cover window arranged over the display layer, the touch sensor, and the pressure sensor.

10. The display device according to claim 9, wherein the cover window is made of glass.

11. The display device according to claim 9, wherein the cover window is made of a flexible film substrate.

12. The display device according to claim 8, wherein the signal processing unit outputs a touch input signal corresponding to a pen input and a pressure signal corresponding to the pen input together.

13. The display device according to claim 8, wherein the display layer is an OLED layer or an LCD layer.

14.The input sensor according to claim 4, wherein the substrate is a flexible substrate.
